(19) United States
(12) Patent Application Publication
(10) Pub. No.: US 2021/0074228 A1
(43) Pub. Date: Mar. 11, 2021

(54) DUAL CELL LCD APPARATUS, CONTROL CIRCUIT AND CONTROL METHOD THEREOF

(71) Applicant: NOVATEK Microelectronics Corp., Hsinchu (TW)

(72) Inventors: Hongchun CONG, Shaanxi Province (CN); Jian-Hua LIANG, ShaanXi Province (CN); Xiao ZHANG, ShaanXi Province (CN)

(21) Appl. No.: 16/581,780

(22) Filed: Sep. 25, 2019

(30) Foreign Application Priority Data
Sep. 6, 2019 (CN) 201910841690.6

(51) Int. Cl. G09G 3/36; G09G 3/34; G02F 1/1335; G02F 1/1347

(52) U.S. Cl. CPC G09G 3/3607; G09G 3/3406; G09G 2320/0626; G02F 1/1347; G02F 1/133606

(57) ABSTRACT

A dual cell LCD apparatus that includes a LCD display panel, a backlight circuit and a dual cell LCD control circuit. The LCD display panel includes a back cell and a front cell. The dual cell LCD control circuit includes a back cell control circuit, a backlight control circuit and a front cell control circuit. The back cell control circuit retrieves a plurality of luminance and color parameters of a display frame data to further generate back cell control parameters to control the back cell layer. The backlight control circuit performs a statistics analysis of the display frame data according to the luminance and color parameters to further generate a plurality of duty parameters to control the backlight circuit. The front cell control circuit performs an intensity compensation on the front cell according to the luminance and color parameters, the duty parameters and the display frame data.

### RELATED APPLICATIONS

This application claims priority to China Application Serial Number 201910841690.6, filed Sep. 6, 2019, which is herein incorporated by reference.

### BACKGROUND

### Field of Disclosure

The present disclosure relates to a liquid crystal display technology. More particularly, the present disclosure relates to a dual cell liquid crystal display apparatus, a control circuit and a control method thereof.

### Description of Related Art

Liquid crystal devices are widely used in a variety of display applications. One of the principal reasons for the popularity of liquid crystal displays is their small size and low power consumption. In recent years, the liquid crystal devices having dual cells become more and more popular since an additional layer of liquid crystal cells is beneficial for lowering the amount of light leakage. However, due to the presence of the additional layer of liquid crystal cells, the control mechanism of the liquid crystal devices becomes more complex as well such that both the cost and the area of the liquid crystal devices are increased.

Accordingly, what is needed is a dual cell liquid crystal display apparatus, a control circuit and a control method thereof to address the above issues.

### SUMMARY

An aspect of the present disclosure is to provide a dual cell liquid crystal display (LCD) control circuit that includes a back cell control circuit, a backlight control circuit and a front cell control circuit. The back cell control circuit is configured to retrieve a plurality of luminance and color parameters of a display frame data to further generate back cell control parameters to control a back cell layer of a LCD display panel. The backlight control circuit is configured to perform a statistics analysis of the display frame data according to the luminance and color parameters to further generate a plurality of duty parameters to control a backlight circuit. The front cell control circuit is configured to perform an intensity compensation on a front cell layer of the LCD display panel according to the luminance and color parameters, the duty parameters and the display frame data.

Another aspect of the present disclosure is to provide a dual cell LCD control method used in a dual cell LCD control circuit that includes the steps outlined below. A plurality of luminance and color parameters of a display frame data are retrieved by a back cell control circuit to further generate back cell control parameters to control a back cell layer of a LCD display panel. A statistics analysis of the display frame data is performed according to the luminance and color parameters by a backlight control circuit to further generate a plurality of duty parameters to control a backlight circuit. An intensity compensation is performed on a front cell layer of the LCD display panel according to the luminance and color parameters, the duty parameters and the display frame data by a front cell control circuit.

Yet another aspect of the present disclosure is to provide a dual cell LCD apparatus that includes a LCD display panel, a backlight circuit and a dual cell LCD control circuit. The LCD display panel includes a back cell and a front cell. The dual cell LCD control circuit includes a back cell control circuit, a backlight control circuit and a front cell control circuit. The back cell control circuit is configured to retrieve a plurality of luminance and color parameters of a display frame data to further generate back cell control parameters to control the back cell layer. The backlight control circuit is configured to perform a statistics analysis of the display frame data according to the luminance and color parameters to further generate a plurality of duty parameters to control the backlight circuit. The front cell control circuit is configured to perform an intensity compensation on the front cell according to the luminance and color parameters, the duty parameters and the display frame data.

These and other features, aspects, and advantages of the present disclosure will become better understood with reference to the following description and appended claims.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a block diagram of a dual cell LCD apparatus in an embodiment of the present invention;

FIG. 2 is a block diagram of the dual cell LCD control circuit in an embodiment of the present invention; and

FIG. 3 is a flow chart of a dual cell LCD control method in an embodiment of the present invention.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

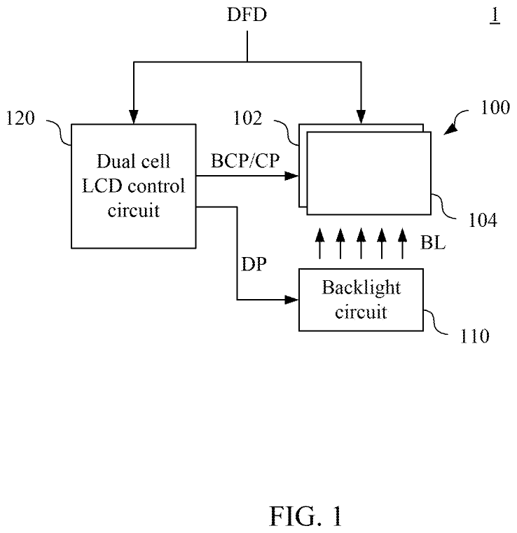

Reference is now made to FIG. 1. FIG. 1 is a block diagram of a dual cell LCD apparatus 1 in an embodiment of the present invention. The dual cell LCD apparatus 1 includes a LCD display panel 100, a backlight circuit 110 and a dual cell LCD control circuit 120.

The LCD display panel 100 includes a back cell layer 102 and a front cell layer 104, in which both the back cell layer 102 and the front cell layer 104 include liquid crystal molecules. In an embodiment, the front cell layer 104 is configured to display a display frame according to a display frame data DFD, and the back cell layer 102 is configured to lower the amount of light leakage of the LCD display panel 100.

It is appreciated that the configuration illustrated in FIG. 1 is merely used to describe the concept of the operation. In practical implementation, the display frame data DFD may be transmitted to the LCD display panel 100 through such as, but not limited to a driving circuit (not illustrated).

The backlight circuit 110 is configured to generate a backlight BL to provide illumination to the LCD display panel 100.

The dual cell LCD control circuit 120 is configured to control the back cell layer 102, the front cell layer 104 and the backlight circuit 110 to accomplish a better control of the amount of illumination for displaying the display frame.

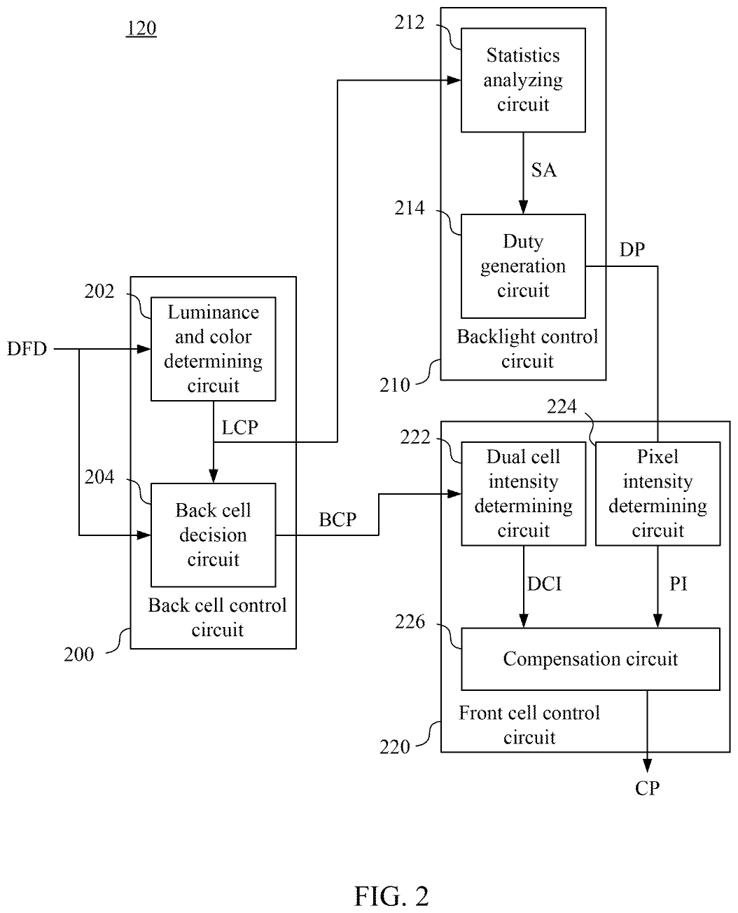

Reference is now made to FIG. 2 at the same time. FIG. 2 is a block diagram of the dual cell LCD control circuit 120 in an embodiment of the present invention. The dual cell LCD control circuit 120 includes a back cell control circuit 200, a backlight control circuit 210 and a front cell control circuit 220.

As illustrated in FIG. 2, the back cell control circuit 200 includes a luminance and color determining circuit 202 and a back cell decision circuit 204.

The luminance and color determining circuit 202 is configured to receive the display frame data DFD and retrieve luminance and color parameters LCP from the display frame data DFD.

In an embodiment, the luminance and color parameters LCP are retrieved in a region-wise manner. More specifically, the display frame data DFD may be segmented into different parts corresponding to different regions of the LCD display panel 100 such that a maximum or an average of the luminance and color intensities of each of these regions is retrieved as one of the luminance and color parameters LCP.

The back cell decision circuit 204 is configured to generate back cell control parameters BCP according to the display frame data DFD and the luminance and color parameters LCP to control an aperture ratio of the back cell layer 102 illustrated in FIG. 1. It is appreciated that when the luminance and color parameters LCP are retrieved in the region-wise manner, the back cell control parameters BCP also control the aperture ratio of the back cell layer 102 in the region-wise manner.

The backlight control circuit 210 includes a statistics analyzing circuit 212 and a duty generation circuit 214.

The statistics analyzing circuit 212 is configured to receive the luminance and color parameters LCP from the back cell control circuit 200 to perform the statistics analysis on different frame regions of the display frame data DFD to generate a plurality of statistics analysis results SA.

As a result, the statistics analyzing circuit 212 perform the statistics analysis in a region-wise manner, in which the display frame data DFD may be segmented into different frame regions corresponding to different regions of the LCD display panel 100 such that a maximum or an average of the intensities of each of these frame regions is calculated as the statistics analysis results SA.

In an embodiment, when the luminance and color determining circuit 202 retrieves the luminance and color parameters LCP in the region-wise manner, the statistics analyzing circuit 212 may directly use the regions corresponding to the luminance and color parameters LCP to calculate the statistics analysis results SA or further groups these regions into larger regions to calculate the statistics analysis results SA.

More specifically, both the luminance and color determining circuit 202 and the statistics analyzing circuit 212 require luminance information of the display frame data DFD. By using the region-wise retrieving and calculating methods described above, the luminance information having lower resolution can be obtained and the luminance and color determining circuit 202 and the statistics analyzing circuit 212 can share such information to reduce the overall amount of calculation.

The duty generation circuit 214 is configured to generate duty parameters DP according to the statistics analysis results SA to control a plurality of duties of backlight regions of the backlight circuit 110 illustrated in FIG. 1 corresponding to the frame regions of the display frame data DFD that the statistics analysis results SA corresponds to.

The front cell control circuit 220 includes a dual cell intensity determining circuit 222, a pixel intensity determining circuit 224 and a compensation circuit 226.

The dual cell intensity determining circuit 222 is configured to receive the back cell control parameters BCP from the back cell control circuit 200 to determine dual cell intensities DCI according to the back cell control parameters BCP.

The pixel intensity determining circuit 224 is configured to receive the duty parameters DP from the backlight control circuit 210 to determine pixel intensities PI according to the duty parameters DP.

The compensation circuit 226 is configured to receive the dual cell intensities DCI from the dual cell intensity determining circuit 222 and receive the pixel intensities PI from the pixel intensity determining circuit 224. Further, the compensation circuit 226 is configured to receive the display frame data DFD to determine original pixel intensities according to the display frame data DFD.

Furthermore, the compensation circuit 226 is configured to generate a plurality of pixel compensation parameters CP according to the dual cell intensities DCI, the pixel intensities PI and the original pixel intensities to perform the intensity compensation on the front cell layer 104 illustrated in FIG. 1.

In some approaches, two separate control circuits are required in order to accomplish both of local dimming of the backlight circuit and the dual cell operation, in which the first control circuit includes a circuit to determine the duties of the backlight circuit and a circuit to perform compensation on the front cell layer according to the duties of the backlight circuit, and the second control circuit includes a circuit to determine the operation of the back cell layer and a circuit to perform compensation on the front cell layer according to the operation of the back cell layer.

The dual cell LCD control circuit 120 of the dual cell LCD apparatus 1 in the present invention is able to perform compensation on the front cell layer 104 simultaneously according to the duties of the backlight circuit 110 and the operation of the back cell layer 102 by disposing a single control circuit. The cost and the area of the dual cell LCD control circuit 120 can both be reduced. Further, due to sharing of the luminance information between the back cell control circuit 200 and the backlight control circuit 210, the overall amount of calculation can be reduce as well.

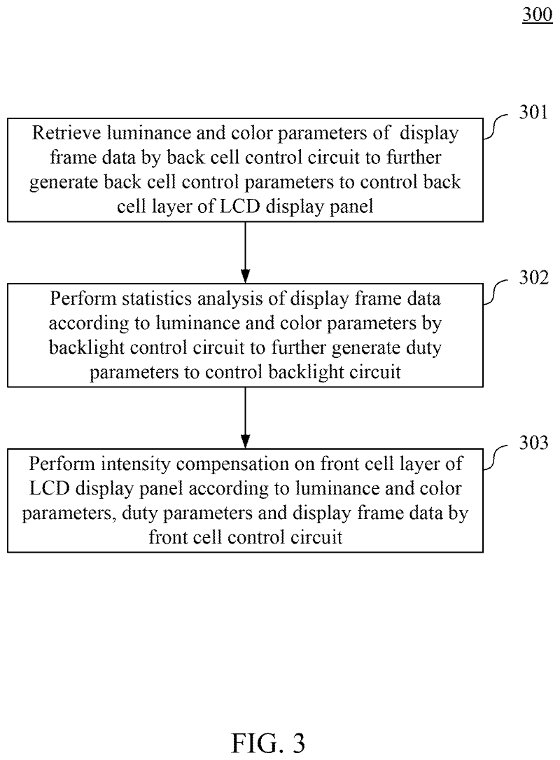

Reference is now made to FIG. 3. FIG. 3 is a flow chart of a dual cell LCD control method 300 in an embodiment of the present invention. The dual cell LCD control method 300 can be used in the dual cell LCD control circuit 120 of the dual cell LCD apparatus 1 illustrated in FIG. 2. The dual cell LCD control method 300 includes the steps outlined below.

In step 301, the luminance and color parameters LCP of the display frame data DFD are retrieved by the back cell control circuit 200 to further generate the back cell control parameters BCP to control the back cell layer 102 of the LCD display panel 100.

In step 302, the statistics analysis SA of the display frame data DFD is performed according to the luminance and color parameters LCP by the backlight control circuit 210 to further generate the duty parameters DP to control the backlight circuit 110.

In step 303, the intensity compensation is performed on the front cell layer 104 of the LCD display panel 100 according to the luminance and color parameters LCP, the duty parameters DP and the display frame data DFD by the front cell control circuit 220.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

1. A dual cell liquid crystal display (LCD) control circuit, comprising:
a back cell control circuit configured to retrieve a plurality of luminance and color parameters of a display frame data to further generate back cell control parameters to control a back cell layer of a LCD display panel;
a backlight control circuit configured to perform a statistics analysis of the display frame data according to the luminance and color parameters to further generate a plurality of duty parameters to control a backlight circuit; and
a front cell control circuit configured to perform an intensity compensation on a front cell layer of the LCD display panel according to the luminance and color parameters, the duty parameters and the display frame data.

2. The dual cell LCD control circuit of claim 1, wherein the back cell control circuit comprises:
a luminance and color determining circuit configured to receive the display frame data and retrieve the luminance and color parameters from the display frame data; and
a back cell decision circuit configured to generate the back cell control parameters according to the display frame data and the luminance and color parameters to control an aperture ratio of the back cell layer.

3. The dual cell LCD control circuit of claim 2, wherein the backlight control circuit comprises:
a statistics analyzing circuit configured to receive the luminance and color parameters from the back cell control circuit to perform the statistics analysis on different frame regions of the display frame data to generate a plurality of statistics analysis results; and
a duty generation circuit configured to generate the duty parameters according to the statistics analysis results to control a plurality of duties of backlight regions of the backlight circuit corresponding to the frame regions.

4. The dual cell LCD control circuit of claim 3, wherein the statistics analysis is to calculate a maximum or an average of intensities of the different frame regions of the display frame data.

5. The dual cell LCD control circuit of claim 3, wherein the front cell control circuit comprises:
a dual cell intensity determining circuit configured to determine dual cell intensities according to the back cell control parameters;
a pixel intensity determining circuit configured to determine pixel intensities according to the duty parameters; and
a compensation circuit configured to determine original pixel intensities according to the display frame data to generate a plurality of pixel compensation parameters according to the dual cell intensities, the pixel intensities and the original pixel intensities to perform the intensity compensation on the front cell layer.

6. A dual cell LCD control method used in a dual cell LCD control circuit, comprising:
retrieving a plurality of luminance and color parameters of a display frame data by a back cell control circuit to further generate back cell control parameters to control a back cell layer of a LCD display panel;
performing a statistics analysis of the display frame data according to the luminance and color parameters by a backlight control circuit to further generate a plurality of duty parameters to control a backlight circuit; and
performing an intensity compensation on a front cell layer of the LCD display panel according to the luminance and color parameters, the duty parameters and the display frame data by a front cell control circuit.

7. The dual cell LCD control method of claim 6, further comprising:
receiving the display frame data and retrieving the luminance and color parameters from the display frame data by a luminance and color determining circuit of the back cell control circuit; and
generating the back cell control parameters according to the display frame data and the luminance and color parameters to control an aperture ratio of the back cell layer by a back cell decision circuit of the back cell control circuit.

8. The dual cell LCD control method of claim 7, further comprising:
receiving the luminance and color parameters from the back cell control circuit by a statistics analyzing circuit of the backlight control circuit to perform the statistics analysis on different frame regions of the display frame data to generate a plurality of statistics analysis results; and
generating the duty parameters according to the statistics analysis results by a duty generation circuit of the backlight control circuit to control a plurality of duties of backlight regions of the backlight circuit corresponding to the frame regions.

9. The dual cell LCD control method of claim 8, further comprising:
performing the statistics analysis by calculating a maximum or an average of intensities of the different frame regions of the display frame data.

10. The dual cell LCD control method of claim 8, further comprising:
determining dual cell intensities according to the back cell control parameters by a dual cell intensity determining circuit of the front cell control circuit;
determining pixel intensities according to the duty parameters by a pixel intensity determining circuit of the front cell control circuit; and
determining original pixel intensities according to the display frame data to generate a plurality of pixel compensation parameters according to the dual cell intensities, the pixel intensities and the original pixel intensities by a compensation circuit of the front cell control circuit to perform the intensity compensation on the front cell layer.

11. A dual cell liquid crystal display (LCD) apparatus, comprising:
a LCD display panel comprising a back cell layer and a front cell layer;
a backlight circuit; and
a dual cell LCD control circuit comprising:
a back cell control circuit configured to retrieve a plurality of luminance and color parameters of a display frame data to further generate back cell control parameters to control the back cell layer;
a backlight control circuit configured to perform a statistics analysis of the display frame data according to the luminance and color parameters to further generate a plurality of duty parameters to control the backlight circuit; and
a front cell control circuit configured to perform an intensity compensation on the front cell layer according to the luminance and color parameters, the duty parameters and the display frame data.

12. The dual cell LCD apparatus of claim 11, wherein the back cell control circuit comprises:
a luminance and color determining circuit configured to receive the display frame data and retrieve the luminance and color parameters from the display frame data; and
a back cell decision circuit configured to generate the back cell control parameters according to the display frame data and the luminance and color parameters to control an aperture ratio of the back cell layer.

13. The dual cell LCD apparatus of claim 12, wherein the backlight control circuit comprises:
a statistics analyzing circuit configured to receive the luminance and color parameters from the back cell control circuit to perform the statistics analysis on different frame regions of the display frame data to generate a plurality of statistics analysis results; and
a duty generation circuit configured to generate the duty parameters according to the statistics analysis results to control a plurality of duties of backlight regions of the backlight circuit corresponding to the frame regions.

14. The dual cell LCD apparatus of claim 13, wherein the statistics analysis is to calculate a maximum or an average of intensities of the different frame regions of the display frame data.

15. The dual cell LCD apparatus of claim 13, wherein the front cell control circuit comprises:
a dual cell intensity determining circuit configured to determine dual cell intensities according to the back cell control parameters;
a pixel intensity determining circuit configured to determine pixel intensities according to the duty parameters; and
a compensation circuit configured to determine original pixel intensities according to the display frame data to generate a plurality of pixel compensation parameters according to the dual cell intensities, the pixel intensities and the original pixel intensities to perform the intensity compensation on the front cell layer.
